(19) United States
(12) Patent Application Publication
(10) Pub. No.: US 2013/0327727 A1
(43) Pub. Date: Dec. 12, 2013

(54) Apparatus and Method for Fluid Separation

(71) Applicant: Hans P Hopper, Aberdeenshire (GB)

(72) Inventor: Hans P Hopper, Aberdeenshire (GB)

(73) Assignee: Cameron International Corporation, Houston, TX (US)

(21) Appl. No.: 13/976,383

(22) PCT Filed: Dec. 28, 2011
(86) PCT No.: PCT/US11/67625

§ 371 Date: Aug. 29, 2013

(30) Foreign Application Priority Data
Dec. 30, 2010 (GB) 1022100.0

(51) Int. Cl. B01D 17/02; E21B 33/03; E21B 33/035; E21B 43/00

(52) U.S. Cl. CPC B01D 17/0217; E21B 43/00; E21B 33/03; E21B 33/035
USPC 210/787; 137/808; 137/13; 166/75.11; 166/368; 166/369

(57) ABSTRACT

An apparatus for controlling the flow of a first fluid stream within a bulk rotating fluid stream is disclosed, the apparatus comprising a fluid flow region having a longitudinal axis, within which a rotating flow of fluid may be established; a flow guide having a convex outer surface disposed centrally within the fluid flow region, the convex outer surface of the flow guide extending parallel to the longitudinal axis of the fluid flow region, the convex surface being shaped to induce a spiral coanda effect in the flow of the first fluid stream over the flow guide. The apparatus may be used in the separation of a multiphase fluid and preferably comprises a vessel comprising a separation region; an inlet for the multiphase fluid stream; means for imparting a rotational flow to the fluid stream such that the fluid stream flows in a downstream helical path within the vessel; a conduit extending within the vessel having an opening in the end portion thereof to provide an outlet for a fluid fraction from the separation region of the vessel; a flow guide on the distal end of the conduit, the flow guide having a lateral dimension greater than that of the conduit and a convex outer surface to induce a spiral coanda effect in a flow of fluid over the flow guide, thereby directing the fluid into the opening in the conduit. A method for separating a multiphase fluid stream is also provided.

The present invention relates to a method for controlling the flow of a fluid stream, in particular to separating a fluid stream, especially a multiphase fluid stream, employing a particular fluid flow behaviour and to an apparatus for carrying out the same. The method and apparatus find general use in fluid separation, but are of particular use in the separation of fluid streams produced from subterranean oil and gas wells.

Multiphase fluid streams requiring separation occur in many processing operations. One example is the production of oil and gas from a subterranean well. Fluid streams produced from a well typically comprise a plurality of phases, including one or more liquid phases, in particular oil and/or water, and a gas phase. Further, in many cases the fluid stream is produced with entrained solids, such as sand, gravel and other solid debris from the well. Generally, it is required to separate the various phases in the fluid stream, for example to recover oil and gas, remove entrained solids, and extract any water present for disposal, such as by reinjection into the well.

Apparatus and methods for separating multiphase fluid streams are known in the art and are commonly applied in a wide range of applications. One commonly used approach is cyclone separation, in which the fluid stream is introduced into a vessel, typically cylindrical or conical in shape, so as to flow in a rotating or helical pattern. The lighter fluid phases are caused to concentrate in the axially central region of the vessel, while the relatively heavier fluid phases, together with entrained solids and the like, migrate to the radially outer regions of the vessel. Means are generally provided to collect and remove the thus separated fluid phases from their respective regions of the vessel. One well known arrangement for removing the lighter fluid fractions from the central region of the vessel is to provide a conduit, often referred to as a ‘dip pipe’, extending axially within the vessel and provided with an opening through which the fluid fraction may be removed. The heavier fluid fractions and any entrained solids may be collected in the base of the vessel or by means of a second conduit disposed appropriately with an opening within the vessel. A second conduit of this type is often referred to as a ‘stand pipe’.

In general, the efficiency of the cyclone separators of the aforementioned type rely upon establishing stable, rotating flow patterns within the vessel. A particular problem arising with the cyclonic separation when using a dip pipe arrangement is the formation of a vortex of lighter fluid extending beneath the open end of the dip pipe. The vortex disrupts the circulating flow patterns and acts to draw heavier fluid and/or entrained solids into the dip pipe along with the lighter fluid fraction. Accordingly, it is known to provide such arrangements with a device on the end portion of the dip pipe to disrupt or ‘break’ the vortex.

A recent example of a separation apparatus employing cyclonic separation with a dip pipe arrangement and a vortex breaker is disclosed in WO 2007/144631. There is disclosed an apparatus for separating clean fluid streams from a multiphase fluid stream containing entrained solids. The apparatus includes an enhancement that separates the multiphase stream into a gas stream, one or more liquid streams and a solids-containing stream. The apparatus comprises a vessel, into which a multiphase fluid, such as that produced from an oil and/or gas well, is introduced so as to flow in a generally helical flowpath. A central conduit extends axially within the vessel and is provided with a plurality of openings in its end portion, through which lighter fluid factions are removed from the central region of the vessel. A fluid guide is provided on the end of the conduit to disseminate the upward flowing vortex and to urge the heavier fluid fraction to the radially outer regions of the vessel.

It has now been found that the separation efficiency of a cyclonic separation apparatus of the aforementioned general type can be increased. In particular, it has been found that flow guide, such as a vortex breaker, can be employed to induce a fluid flow pattern similar to a coanda effect to occur in the flow of fluid towards and into openings in a centrally disposed conduit.

Accordingly, in a first, general aspect, the present invention provides an apparatus for controlling the flow of a first fluid stream within a bulk rotating fluid stream, the apparatus comprising:

a fluid flow region having a longitudinal axis, within which a rotating flow of fluid may be established;

a flow guide having a convex outer surface disposed centrally within the fluid flow region, the convex outer surface of the flow guide extending parallel to the longitudinal axis of the fluid flow region, the convex surface being shaped to induce a spiral coanda effect in the flow of the first fluid stream over the flow guide.

The apparatus is of particular use in the separation of multiphase fluid streams, in which the first fluid stream is a generally lighter fluid fraction, that collects in the radially innermost region of the fluid flow region, with the generally heavier fluid fractions collecting radially outwards of the innermost region. By employing the spiral coanda effect, the apparatus allows the first fluid stream to flow within the fluid flow region over the surface of the flow guide, either in the upstream direction or downstream direction, in particular to maintain or enhance separation of the phases of the fluid stream. A particularly advantageous application of the spiral coanda effect is in the separation of multiphase fluid streams, in particular to direct the first fluid stream towards an outlet.

In a further, more particular aspect, the present invention provides an apparatus for the separation of a multiphase fluid stream, the apparatus comprising:

a vessel comprising a separation region;

an inlet for the multiphase fluid stream;

means for imparting a rotational flow to the fluid stream such that the fluid stream flows in a downstream helical path within the vessel;

a conduit extending within the vessel having an opening in the end portion thereof to provide an outlet for a fluid fraction from the separation region of the vessel;

a flow guide on the distal end of the conduit, the flow guide having a lateral dimension greater than that of the conduit and a convex outer surface to induce a spiral coanda effect in a flow of fluid over the flow guide, thereby directing the fluid into the opening in the conduit.

The coanda effect is described in U.S. Pat. No. 2,086,569 in the name of Henri Coanda, who identified that a flow of fluid passing over a smooth convex surface tends to change direction and follow the convex surface, rather than travel in a straight line. This two-dimensional linear direction phenomenon is known as ‘the coanda effect’. It has been found that a fluid flow pattern similar to the coanda effect can be induced by use of an appropriate convex surface in a fluid that is moving in a rotating or helical pattern. It has further been found that this effect can be used to position and control the direction of flow of fluid adjacent the convex surface within an apparatus to effect or enhance the fluid separation characteristics of the apparatus.

In particular, the present invention employs the effect of causing a rotating flow of fluid to follow the curvature of a convex body disposed within the flowpath of the fluid stream. In this way, the fluid adjacent the surface of the convex body may be caused to flow in a desired direction, either in a general upstream or general downstream direction, for example towards an opening disposed on, adjacent or near to the convex body. It has been found that the stream of fluid moving over the surface of the convex body due to the spiral coanda effect may flow in a stable and well defined manner, maintaining segregation or separation of the stream from the surrounding bulk rotating fluid stream, thereby reducing or eliminating mixing and contamination of the separated fluid streams.

It has been found that the surface of the convex body, such as a flow guide, may be arranged to locate the position at which the flow of fluid over the surface leaves the surface, the so-called ‘breakaway point’, as required, for example adjacent or close to an outlet, into which the fluid is then caused to flow.

The apparatus of the present invention operates to separate multiphase fluid streams by imparting to the incoming fluid stream a rotational flow pattern, such that the fluid follows a general helical or spiral flow path within the vessel away from the fluid inlet. References herein to the terms ‘upstream’ and ‘downstream’ are references to the general direction of flow of the fluid stream within the vessel away from the fluid inlet.

The apparatus comprises a vessel having a separation region therein, that is a region within the vessel in which the phases of the multiphase fluid stream are caused to separate. The vessel may be of any suitable configuration and such vessels are known in the art. In one embodiment, the vessel has a generally cylindrical interior, at least in the separation region. Alternatively, the vessel may have a conical form, as is known in the art, or a combination of a cylindrical portion immediately downstream of the fluid inlet and a conical section downstream of the cylindrical portion. Other vessel arrangements will be apparent to the person skilled in the art.

The vessel is provided with an inlet for the multiphase fluid stream. A single inlet may be provided. Alternatively, the vessel may be provided with two or more inlets to allow fluid to be introduced into the vessel at different regions. The inlet may have any suitable configuration. In one preferred embodiment, the inlet is provided with a rectangular cross-section, such that the fluid entering the vessel does so through a rectangular opening in the inlet. The inlet may be arranged in any suitable orientation relative to the vessel. In one particularly preferred embodiment, the fluid inlet is arranged at an angle to the radial axis of the vessel, more preferably at a tangent to the radial axis of the vessel. In this way, the fluid is introduced in a manner that causes it to rotate and swirl within the vessel and the separation region therein. The inlet may arranged in any suitable orientation relative to the longitudinal axis of the vessel, for example may extend perpendicular to the longitudinal axis. A preferred embodiment is one in which the inlet extends at an angle to the longitudinal axis of the vessel, such that fluid entering the vessel is directed downstream of the fluid inlet in a helical path. Most preferably, the fluid stream is introduced into the separation region at an angle, such that the incoming fluid is directed in a helical flowpath in the generally downstream direction, with the inlet being at an angle that prevents the incoming fluid from colliding with the fluid present and rotating within the vessel.

The apparatus comprises means for imparting a rotational flow pattern to the fluid entering the vessel and the separation region therein. Any suitable means may be provided to impart the rotational flow pattern. As noted above, one particularly preferred embodiment employs the angle of the fluid inlet to induce a rotational flow pattern in the fluid within the vessel. Alternatively, or in addition thereto, the fluid may be caused to follow a rotational flow pattern by means of one or more guides or guide surfaces within the vessel.

The apparatus further comprises a conduit extending into the separation region within the vessel. The conduit provides a means for removing a fluid fraction, that is, for example, a fluid fraction of relatively lower density, from the separation region. The conduit may have any suitable configuration. A tube or pipe is a most suitable form of conduit.

The conduit may extend in any suitable orientation into the separation region within the vessel. In one preferred arrangement, the conduit extends axially within the vessel into the separation region.

The conduit may be disposed to remove either a heavier fluid fraction or a lighter fluid fraction. In one preferred embodiment, the conduit provides an outlet for a lighter fluid fraction collected in the central portion of the separation region. It has been found that the spiral coanda effect is particularly effective in directing the flow of a lighter fraction, such as a gas or a low density liquid, from the central portion of the separation region into a suitably disposed opening in a conduit. Accordingly, the apparatus preferably comprises:

a conduit extending within the vessel having an opening in the end portion thereof to provide an outlet for a lighter fluid fraction from a central region of the separation region of the vessel; and

a flow guide on the distal end of the conduit and disposed downstream of the opening in the end portion of the conduit, the flow guide having a convex surface and a lateral dimension greater than that of the conduit and an outer surface to induce a spiral coanda effect in a flow of lighter fluid over the flow guide, thereby directing the lighter fluid into the opening in the conduit.

In one preferred embodiment, the lighter fluid is caused to flow over the surface of the flow guide in an upstream direction towards the opening in the conduit. In this preferred embodiment, the conduit preferably extends into the separation region from the upstream end of the vessel, more preferably coaxially within the vessel. Such a conduit may be referred to the in the art as a ‘dip pipe’. In this way, the lighter fluid fraction is removed from the upstream end of the vessel by way of the conduit.

In embodiments where the conduit is for removing a heavier liquid fraction, the fluid stream flowing over the surface of the flow guide is caused to flow in the downstream direction towards the outlet. In this arrangement, the conduit may extend from the downstream end of the vessel, preferably coaxially within the vessel. Such a conduit may be referred to in the art as a ‘stand pipe’. In this way, the heavier fluid fraction is removed from the downstream end of the separation region and the vessel.

The conduit is provided with an opening in the portion adjacent its distal end through which the fluid fraction may leave the separation region and enter the conduit, for removal from the vessel. The opening may have any suitable configuration. The opening is preferably provided in the wall of the conduit such that it faces outwards, preferably radially outwards, and allows an inward flow of fluid to pass therethrough and enter the conduit. More preferably, the opening in the conduit is arranged to extend tangentially to the direction of rotation of the flow of fluid within the vessel and allows fluid to flow tangentially inwards into the conduit. In one preferred arrangement, the opening is provided in a portion of the wall of the conduit extending parallel to the longitudinal axis of the vessel and separation region.

The opening may comprise a single aperture. More preferably, the opening comprises a plurality of apertures in the conduit, most preferably disposed around the circumference of the conduit. The opening may be disposed only adjacent the distal end of the conduit. Alternatively, the opening may be disposed at a position displaced from the distal end of the conduit.

In the case that the conduit is providing an outlet for lighter fluid collected in the radially central portion of the separation region, the opening is disposed in a portion of the conduit extending upstream from the distal end. In embodiments in which the conduit is for heavier fluid fractions, the opening is disposed in a portion of the conduit downstream of the flow guide and the distal end of the conduit.

The apparatus is further provided with a flow guide at the distal end of the conduit. The flow guide may serve a number of functions. For example, the flow guide, when disposed on the conduit for removing lighter fluid, such as at the distal end of a dip pipe, may act as a vortex controller, to control the formation and shape of a vortex of lighter fluid in the central portion of the separation region. Such a vortex generally arises when the conduit is provided with an open distal end. As the vortex forms, lighter fluid flows in an upstream direction into the conduit. This can cause a local pressure drawdown within the separation region. The pressure drawdown caused by the vortex can affect the general rotating flow patterns established in the separation region and decrease the separation efficiency of the apparatus, in particular by causing fluid from the radially outer regions of the vessel to flow towards and enter the conduit. This in turn re-mixes fluid streams separated within the separation region, contaminating the fluid stream entering the conduit. The use of a flow guide having a convex surface to generate a spiral coanda flow of fluid over its surface towards the conduit reduces or eliminates this re-mixing of the fluid streams, improving separation efficiency.

More importantly, the flow guide provides a surface over which the fluid fraction can flow within the separation region and into the opening in the conduit. In the case of a flow guide disposed to enhance the removal of lighter fluid from the central portion of the separation region, the flow guide induces a spiral coanda flow over the convex surface of the flow guide in the flow of lighter fluid, directing the fluid radially inwards and into the opening in the conduit disposed upstream of the flow guide.

Similarly, the flow guide can be provided to induce a coanda effect in a flow of heavier fluid, to enhance the removal of the heavier fluid fraction from the separation region. In this case, the heavier fluid is caused to flow over the convex surface of the flow guide under the spiral coanda effect, to enter an opening in the conduit downstream of the flow guide.

The flow guide has a lateral dimension that is greater than that of the conduit. The surface of the flow guide is formed to induce a spiral coanda flow of fluid around the flow guide. The fluid flowing over the flow guide is flowing in a general direction within the separation region. In the case of a lighter fluid being collected from a central portion of the separation region, the fluid flows in an upstream direction over the flow guide. Heaver fluid continues to flow from the inlet in a general downstream direction within the separation region. However, the fluid is also flowing in a rotating pattern following a helical flowpath through the separation region. Thus, considering the flow of fluid in three dimensions, the fluid flowing over the surface of the flow guide is moving in a helical path and the flow guide is shaped to induce a coanda effect in such a helical or spiral fluid flow. The coanda effect causes the fluid to flow radially inwards from the end of the flow guide and to enter the opening in the conduit. This effect is superimposed on the generally spiral or helical flow pattern of the fluid, resulting in the spiral coanda flow.

The surface of the flow guide may have any suitable form to induce the spiral coanda effect in the flow of fluid within the separation zone, thereby directing the fluid into the opening in the conduit. Preferably, the flow guide is provided with a curved surface, more preferably a continuously curved surface, that is presented to the flow of fluid that passes thereover. The lateral dimensions of the flow guide relative to the diameter of the conduit, the length of the flow guide and the curved form of the flow guide surface are selected to induce the sprial coanda effect in the flow of fluid, as hereinbefore described. The required effect is that the flow of fluid leaving the flow guide having passed over the curved surface, is directed rotationally and radially inwards towards the conduit. The precise size and form of the flow guide necessary to induce the required effect will depend upon such factors as the physical properties of the fluid stream and the parameters of the fluid flow, such as velocity and direction. The particular size and form of the flow guide required for a given application may be determined by routine experimentation.

In one preferred arrangement, the curved surface may be considered to be bulbous or bulb-like. In particular, the curved surface of the flow guide extends radially outwards in the downstream direction from the distal end of the conduit to a wide portion and extends radially inwards in the downstream direction of the side portion. The flow guide preferably has a curved or rounded distal end portion. Such a bulb-shaped flow guide disposed on the end of a dip-pipe has been found to be particularly effective in enhancing the removal of lighter fluid that has collected in the central portion of the separation region.

In alternative embodiment, the flow guide is generally dome-shaped, having a curved, domed surface presented to the flow of fluid. Thus, the fluid is presented with a surface that curves radially outwards within the separation region in the direction of flow of the fluid. Such a dome-shaped flow guide disposed on the end of a stand pipe has been found to be particularly effective in enhancing the removal of heavier fluid from the separation region of the vessel.

The apparatus comprises an outlet for lighter fluid, such as a gas or a low density liquid phase, which is removed from the central or radially inward portion of the separation region of the vessel. Suitable arrangements for outlets for lighter fluids from the separation region are known in the art. Preferably, the outlet assembly for the lighter fluid fraction comprises a conduit and flow guide as described hereinbefore. The apparatus further comprises at least one outlet for at least one heavier fluid fraction. A plurality of outlets for different heavier fluid fraction streams may be provided, if desired. The outlet for the heavier fluid fraction may have any suitable arrangement. Suitable outlet arrangements are known in the art. The heavier fluid outlet may comprise a conduit and flow guide as hereinbefore described.

In a preferred arrangement, the apparatus comprises a first conduit extending in downstream direction within the separation region in the vessel and provided with and opening and a flow guide at its distal end, for the removal of a lighter fluid fraction; and a second conduit extending within separation region in the vessel in an upstream direction, the second conduit being provided with an opening through which a heavier fluid fraction is removed from the separation region and a flow guide at its distal end.

In embodiments in which a flow guide is provided to enhance the removal of a heavier fluid fraction from the separation region, the flow guide is preferably provided with one or more ports or channels therethrough, to provide a path for fluid to flow from the downstream region of the flow guide to the region upstream thereof. In this way, the formation of a hydraulic lock below the flow guide is prevented and lighter fluid entrained in and descending with the heavier fluid fraction has a path to return to the upstream central portion of the separation region.

In a further general aspect, the present invention provides a method for controlling the flow of a first fluid stream within a bulk rotating fluid stream, the method comprising:

providing a bulk fluid stream and imparting a rotational flow pattern to the bulk fluid to induce a first fluid fraction to form in the innermost region of the flow pattern;

causing the first fluid fraction to flow as the first fluid stream over the convex surface of a flow guide to induce a spiral coanda effect, thereby allowing the direction and orientation of the flow of the first fluid stream to be controlled.

In a more particular aspect, the present invention provides a method for separating a multiphase fluid stream, the fluid stream comprising a relatively high density component and a relatively low density component, the method comprising:

introducing the multiphase fluid into a separation zone;

imparting a rotational movement into the fluid, whereby a lighter fluid fraction is caused to collect in the radially central region of the separation zone and a heavier fluid faction is caused to collect in the radially outer region of the separation zone;

inducing a spiral coanda flow in a fluid fraction to direct the fluid fraction towards a fluid outlet disposed and thereby removing the fluid fraction from the separation zone.

The method separates a multiphase fluid stream into separate fractions, in particular lighter fractions having a relatively lower density and heavier fractions having a relatively higher density. The multiphase fluid stream may comprise two or more fluid phases, in particular one or more liquid phases, a liquid and a gas phase, or a combination thereof. The fluid stream may also comprise a solid fraction in the form of entrained solids, which can also be removed. The method of the present invention is particularly suitable for the separation of a multiphase fluid stream produced from a subterranean oil and gas well. Such a stream may comprise oil, gas, water and solids, such as entrained sand, gravel and debris from the well.

As described above, the method operates to impart a rotational flow on the fluid stream within the separation zone, separating the fluid phases according to their relative densities. In particular, the heavier fluid phases and/or entrained solids are urged to the outer region of the separation zone, while the lighter fluid phases collect in the radially inner region of the separation zone. The lighter fluids can be removed from within the central region of the separation zone, in particular through an outlet disposed within the central region, the lighter fluids being caused to flow in an upstream direction to the outlet. By inducing a spiral coanda flow in the lighter fluid, it can be directed towards the outlet, thereby improving the separation efficiency of the method. Similarly, heavier fluids moving downstream through the separation zone may also be directed to an outlet using the spiral coanda effect, enhancing their removal from the separation zone.

Within the inner region of the separation zone, a spiral coanda flow of the lighter fluid may be induced over a guide surface, to thereby direct the lighter fluid into an outlet for removal from the separation zone. In one embodiment, the method comprises:

providing an outlet for low density fluid in a central region of the separation zone;

providing a flow guide downstream of the outlet, the flow guide inducing a spiral coanda flow of low density fluid in the upstream direction and directing the low density fluid inwards towards the outlet.

In a further embodiment, the method comprises:

providing an outlet for high density fluid in the separation zone;

providing a flow guide upstream of the outlet, the flow guide inducing a spiral coanda flow of high density fluid in the downstream direction and directing the high density fluid towards the outlet.

As noted, the method and apparatus may be used to separate a wide range of multiphase fluid streams comprising a plurality of phases selected from gas, liquids and solids, such as debris. The method and apparatus are particularly suitable for the separation of a fluid stream produced from a subterranean well. Accordingly, in a further aspect, the present invention provides a wellhead installation comprising an apparatus for separating a multiphase fluid stream as hereinbefore described. The wellhead installation may be located subsea.

Embodiments of the present invention will now be described, by way of example only, having reference to the accompanying drawings, in which:

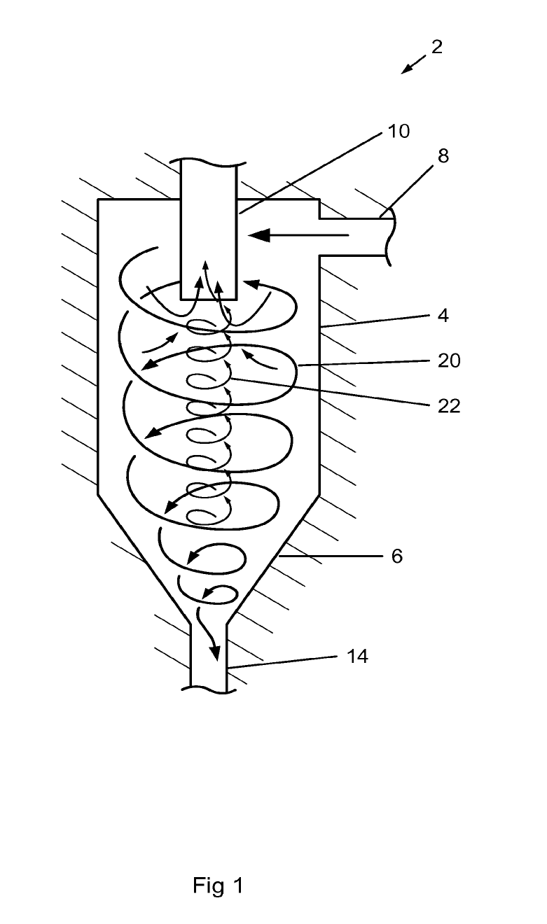

FIG. 1 is a diagrammatic representation of a conventional cyclone separation apparatus for separating the phases of a two-phase fluid stream;

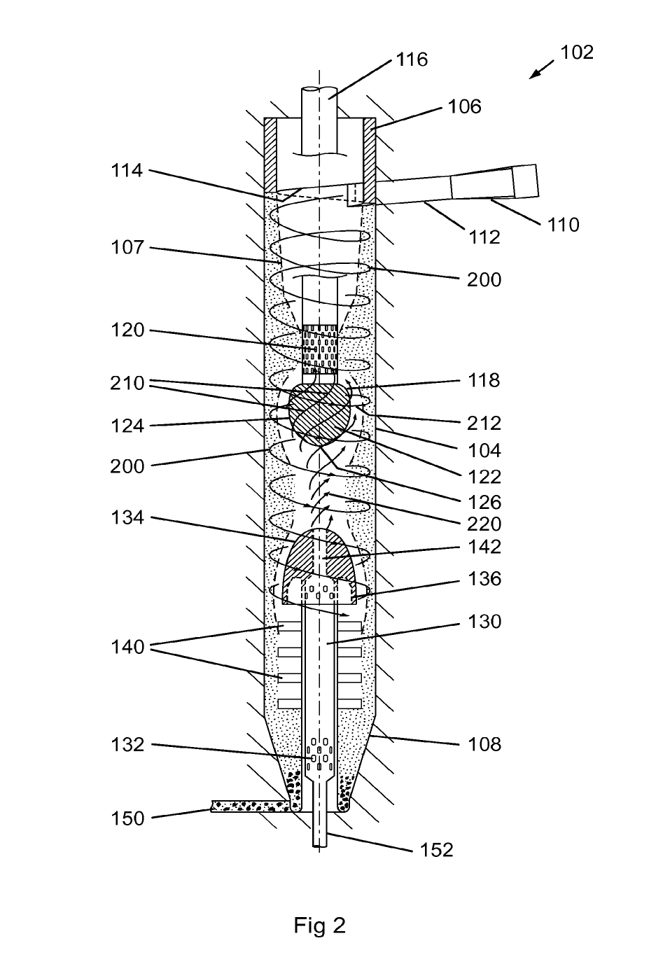

FIG. 2 is a diagrammatic representation of an apparatus according to one embodiment of the present invention;

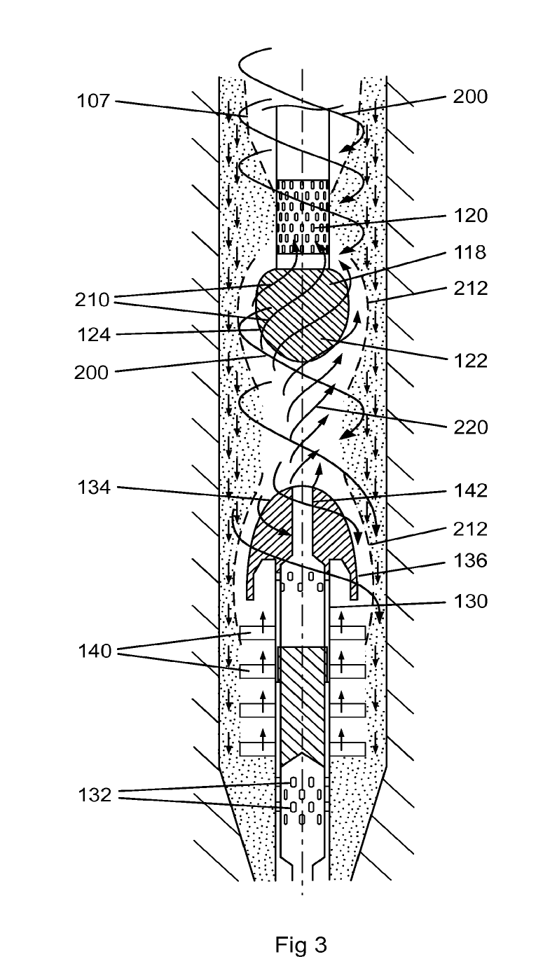

FIG. 3 is an enlarged view of the central portion of the apparatus of FIG. 2; and

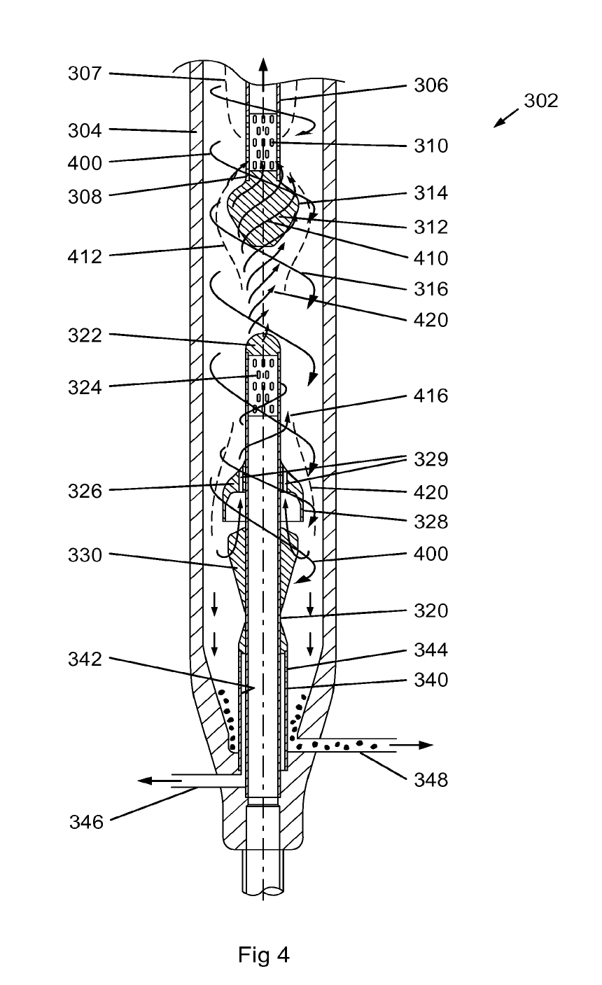

FIG. 4 is a diagrammatic representation of an apparatus according to a second embodiment of the present invention.

Referring to FIG. 1, there is shown a conventional fluid separator of the cyclone-type, generally indicated as 2. The separator 2 comprises a generally cylindrical vessel 4 having a conical lower portion 6, as viewed in the figure. An inlet 8 for fluid is provided at the upstream end of the vessel 4. The inlet 8 is arranged to extend at a tangent to the wall of the vessel 4, such that fluid enters the vessel tangentially, to thereby induce a circulating flow pattern within the vessel. A conduit in the form of an open-ended dip pipe 10 extends from the upstream end of the vessel into the central region of the vessel 4. The dip pipe 10 provides an outlet for lighter fluid phase, which collect in the central region 12 of the vessel when in use. In this respect, the lighter fluid phase may comprise gas and/or low density liquids. Alternatively, the lighter fluid phase may be a clean fluid that is substantially free from heavy components, such as entrained solids and debris. An outlet 14 for heavier fluids and/or entrained solids is provided in the lower or downstream end of the vessel 4.

The flow patterns of fluids within the vessel 4 when the separator 2 is in operation are shown by arrows. The fluid stream enters the vessel 4 through the tangentially arranged inlet 8 and is caused to flow in a rotating pattern in the upstream portion of the vessel. As can be seen, a generally helical fluid flowpath 20 is established below the inlet 8 downwards within the vessel 4, as viewed in the figure. The rotational action of this flow pattern causes the heavier or more dense components of the fluid stream, such as dense liquids and, if present, entrained solids, to move radially outwards and collect at the wall of the vessel 4, while the lighter, less dense fluid components, such as lighter liquids or gases, or solid-free fluid, collect in the central portion 12.

The heavier components, such as more dense liquids or liquid with a high proportion of entrained solids, leave the vessel 4 through the downstream outlet 14. The lighter fluids leave the vessel through the open end of the dip pipe 10. The flow of lighter fluids upstream into the dip pipe is accompanied by the formation of a vortex, represented by arrows 22. The flow of fluid into the open end of the dip pipe and the vortex disturbs the general pattern of fluid separation, in particular in the region of the end of the dip pipe. In particular, the vortex causes a low pressure region in the central portion of the vessel, drawing fluid from the radially outer portions of the vessel inwards, causing cross-flow patterns and eddie currents. This reduces the overall efficiency of separation of the separator 2.

Referring to FIG. 2, there is shown a separator assembly according to one embodiment of the present invention, generally indicated as 102. The separator 102 comprises a generally cylindrical vessel 104 having an upstream end 106 and a conical downstream end 108. An inlet assembly 110 for a multiphase fluid is disposed adjacent the upstream end 106 of the vessel 104. The inlet assembly 110 comprises an inlet pipe 112 having a generally rectangular cross-section. The inlet pipe extends at an angle a to the longitudinal axis of the vessel 104 that is less than 90°, typically about 85°. Further, the inlet pipe 112 opens tangentially into the vessel 104. In this way, fluid entering the upstream end 106 of the vessel 104 does so at a tangent to the interior and is imparted with a rotating flow pattern that is directed in the downstream direction within the vessel. The angle a is selected according to the geometry of the apparatus, to ensure that the fluid entering the vessel 104, after one revolution of the vessel, passes downstream of the opening of the inlet pipe 112. In this way, the incoming fluid avoids directly contacting and impinging on a rotating body of fluid within the vessel. This, in turn, reduces the shear applied to the rotating body of fluid within the vessel and avoids the incoming fluid stream from disturbing the helical flow patterns of fluid already within the vessel.

The inlet pipe 112 is disposed a suitable distance from the upstream end 106 of the vessel, in use to allow for the formation of cap of lighter fluid between the incoming fluid and the upstream end of the vessel.

A ramped surface 114 is provided in the wall of the vessel 104 extending from the opening of the inlet pipe 112 in a downstream helical direction. The ramped surface 114 provides a guide for the incoming fluid, aiding in forming the aforementioned helical flow pattern.

A conduit in the form of a dip pipe 116 extends coaxially within the vessel from the upstream end. The dip pipe 116 is generally cylindrical and extends into the central region of the vessel. Adjacent its distal end 118 the dip pipe is provided with an opening 120 comprising a plurality of apertures dispersed around the circumference of the dip pipe and facing radially outwards into the interior of the vessel, preferably tangentially to the direction of flow of the fluid within the vessel.

A flow guide 122 is disposed on the distal end of the dip pipe 116. The flow guide has a diameter greater than that of the dip pipe 116 and its outer surface is continuously curved from the distal end of the dip pipe in the downstream direction to its widest portion 124. The flow guide is further curved in the downstream direction from the widest portion 124 to its distal end 126 to have a generally bulb shape.

The separator 102 further comprises a conduit extending coaxially from the downstream end in the form of a stand pipe 130. The stand pipe 130 is generally cylindrical and extends into the central region of the vessel. The stand pipe 130 is provided with an opening 132 comprising a plurality of apertures dispersed around the circumference of the stand pipe and facing radially outwards into the interior of the vessel, for the removal of fine solid particles, for example.

A flow guide 134 is provided on the upstream end of the stand pipe 130. The flow guide 134 is generally dome-shaped, having its widest point 136 at its downstream end with a diameter greater than that of the stand pipe 130.

A plurality of rectangular vanes 140 extend radially outwards from the stand pipe into the interior of the vessel 104 between the opening 132 and the flow guide 134. The vanes 140 reduce the rotational flow of fluid within the vessel in this region and provide a region in which solid particles can settle.

The domed flow guide 134 is provided with one or a plurality of channels 142 extending therethrough. The channels 142 connect the region of the interior of the vessel immediately downstream of the flow guide 134 with the upstream region. The channels provide a conduit for lighter fluids to flow upstream through the flow guide. In this way, the formation of a hydraulic lock caused by the accumulation of lighter fluids, in particular entrained gas, downstream of the flow guide is prevented.

An outlet 150 is provided in the downstream end 108 of the vessel, extending tangentially outwards from the interior of the vessel. The outlet 150 may be used to remove the heaviest liquid phases and/or liquid with entrained solids and debris.

In operation, a multiphase fluid stream is provided to the separator 102 through the inlet assembly 110. The operation will be described, by way of example only, with reference to a fluid stream comprising gas, oil, water and entrained solids. The fluid stream enters the vessel 104 via the inlet pipe 112 and is directed into a helical flow pattern by the angle of the inlet pipe 112 and the ramped surface 114, as hereinbefore described. The helical flow pattern is indicated by arrows 200. As can be seen, in particular in FIG. 3, the fluid stream rotates within the vessel as it flows in a downstream direction away from the inlet pipe 112 and the upstream end. Gas is collected in the radially central region of the vessel 104 as the fluid stream rotates, while the heavier liquid phases and the entrained solids move radially outwards towards the wall of the vessel 104. Gas collects in the region of the interior of the vessel between the inlet pipe 112 and the upstream end 106 and forms a gas cap.

The gas, and possibly lighter liquid phases (hereafter referred to collectively as ‘gas’), collected in the central region of the vessel flows through the opening 120 in the dip pipe 116 and leaves the vessel. The flow of gas into the dip pipe through the opening 120 induces a generally upstream flow of gas from the central region. The gas flows from downstream of the dip pipe and the flow guide 122 in a helical upstream path over the surface of the flow guide 124, as indicated by the arrows 210. As the gas passes over the widest portion 124 of the flow guide 122, it urges the fluids flowing in a downstream direction, in particular the liquid fractions and entrained solids, towards the wall of the vessel, enhancing separation of the gas and liquid phases. Further, the flow guide 122 induces a spiral coanda effect in the upstream spiral of gas. As the gas leaves the upstream end of the flow guide, the spiral coanda effect directs the gas radially inwards towards the opening 120 in the dip pipe, assisting in the removal of gas from the central region of the vessel.

As shown in FIG. 3, two distinct fluid streams are formed in the region of the flow guide 122. The first fluid stream is the flow of fluid over the surface of the flow guide in the upstream direction, induced by the spiral coanda effect. The second stream is the bulk fluid stream rotating within the vessel, with the heavier fluid components collecting in the radially outer regions of the vessel. The first and second fluid streams are separated by a boundary 212.

There is a tendency for a vortex 220 to form downstream from the dip pipe, due to the upstream flow of gas. The flow guide 122 controls the vortex and generates a stable flow of fluid around the flow guide in the upstream direction due to the spiral coanda effect.

Downstream of the distal end 118 of the dip pipe 116 and the flow guide 122, the heavier liquid fractions and entrained solids continue to flow in a helical path, as indicated by arrows 200. The liquid flows over the surface of the flow guide 134 on the distal end of the stand pipe 130. The curved surface of the flow guide 134 induces a spiral coanda effect in the liquid flowing thereover, further enhancing the separation of the oil and water phases and entrained solids. In particular, the spiral coanda effect forms a rotational layer of fluid around the flow guide 134 with a flow in the downstream direction. Heavier liquid phases and entrained solids move outwards towards the wall of the vessel.

Downstream of the flow guide, the vanes 140 slow the rotation of the liquid. Medium to fine solid particles entrained in heavier fluid are withdrawn from the central region of the vessel through the opening 132 in the stand pipe 130 and leaves the vessel. Liquid and larger particles of entrained solids settle in the downstream end portion 108 of the vessel and are removed from the vessel through the outlet 150.

Turning to FIG. 4, there is a shown a diagrammatic representation of a further embodiment of a separator assembly of the present invention. The separator assembly, generally indicated as 302, comprises a generally cylindrical vessel 304 and has an inlet and upstream arrangement as shown in FIG. 2 and described hereinbefore.

A conduit in the form of a dip pipe 306 extends coaxially within the vessel from the upstream end. The dip pipe 306 is generally cylindrical and extends into the central region of the vessel 304. Adjacent its distal end 308 the dip pipe is provided with an opening 310 comprising a plurality of apertures dispersed around the circumference of the dip pipe and facing radially outwards into the interior of the vessel, preferably tangentially to the direction of flow of the fluid within the vessel.

A flow guide 312 is disposed on the distal end of the dip pipe 306. The flow guide has a diameter greater than that of the dip pipe 306 and its outer surface is continuously curved from the distal end of the dip pipe in the downstream direction to its widest portion 314. The flow guide is further curved in the downstream direction from the widest portion 314 to its distal end 316 to have a generally bulb shape.

The separator 302 further comprises a conduit extending coaxially from the downstream end in the form of a stand pipe 320. The stand pipe 320 is generally cylindrical and extends into the central region of the vessel. The stand pipe 320 is provided with a generally dome-shaped end cap 322 at its distal end. The stand pipe 320 is further provided with an opening 324 adjacent the end cap 322 comprising a plurality of apertures dispersed around the circumference of the stand pipe and facing radially outwards into the interior of the vessel.

A flow guide 326 is provided around the stand pipe 320 downstream of the opening 324. The flow guide 326 is generally dome-shaped, having its widest point 328 at its downstream end with a diameter greater than that of the stand pipe 320. The domed flow guide 326 is provided with a plurality of channels 329 extending therethrough. The channels 329 connect the region of the interior of the vessel immediately downstream of the flow guide 326 with the upstream region. The channels provide a conduit for lighter fluids to flow upstream through the flow guide.

In this way, the formation of a hydraulic lock caused by the accumulation of lighter fluids, in particular entrained gas, downstream of the flow guide is prevented.

Downstream of the flow guide 326, the stand pipe 320 is further provided with a second flow guide 330, in the form of a generally inverted cone. The second flow guide is arranged such that at its upstream end it reduces the cross-sectional area of the vessel available for the flow of fluid in the downstream direction, with the conical surface of the second flow guide causing the cross-sectional area of the vessel available for the flow of liquid to increase in the downstream direction.

Downstream of the second flow guide 326, the stand pipe 320 is provided with an outer pipe 340 extending therearound to form an annular conduit 342 between the outer conduit and the stand pipe. The outer pipe 340 is provided with an opening 344 comprising a plurality of apertures extending around the conduit at its upstream end. The annular conduit 342 extends to the downstream end of the vessel 304 and connects with an outlet 346, through which a fluid stream may be removed from the vessel.

An outlet 348 is provided in the downstream end of the vessel 304, communicating with the interior of the vessel and extending tangentially outwards from the interior of the vessel. The outlet 348 may be used to remove the heaviest liquid phases and/or liquid with entrained solids and debris.

In operation, a multiphase fluid stream is provided to the separator 302 through the inlet assembly. The operation will be described, by way of example only, with reference to a fluid stream comprising gas, oil, water and entrained solids. The fluid stream enters the vessel 304 via the inlet pipe and establishes a helical flow pattern within the vessel, as hereinbefore described with reference to FIGS. 2 and 3. The helical flow pattern is indicated by arrows 400. As can be seen, the fluid stream rotates within the vessel as it flows in a downstream direction away from the inlet pipe and the upstream end. Gas is collected in the radially central region of the vessel 304 as the fluid stream rotates, while the heavier liquid phases and the entrained solids move radially outwards towards the wall of the vessel 304. Gas collects in the region of the interior of the vessel between the inlet pipe and the upstream end and forms a gas cap (not shown in FIG. 4 for clarity).

The gas collected in the central region of the vessel flows through the opening 310 in the dip pipe 306 and leaves the vessel. The flow of gas into the dip pipe through the opening 310 induces a generally upstream flow of gas from the central region. The gas flows from downstream of the dip pipe and the flow guide 312 in a helical upstream path over the surface of the flow guide 124, as indicated by the arrows 410. As the gas passes over the widest portion of the flow guide 312, it urges the fluids flowing in a downstream direction, in particular the liquid fractions and entrained solids, towards the wall of the vessel, enhancing separation of the gas and liquid phases. Further, the flow guide 312 induces a spiral coanda effect in the upstream spiral of gas. As the gas leaves the upstream end of the flow guide, the spiral coanda effect directs the gas radially inwards towards the opening 310 in the dip pipe, assisting in the removal of gas from the central region of the vessel.

As shown in FIG. 4, two distinct fluid streams are formed in the region of the flow guide 312. The first fluid stream is the flow of fluid over the surface of the flow guide in the upstream direction, induced by the spiral coanda effect. The second stream is the bulk fluid stream rotating within the vessel, with the heavier fluid components collecting in the radially outer regions of the vessel. The first and second fluid streams are separated by a boundary 412.

There is a tendency for a vortex 420 to form downstream from the dip pipe, due to the upstream flow of gas. The flow guide 312 controls the vortex and generates a stable flow of fluid around the flow guide in the upstream direction due to the spiral coanda effect.

Downstream of the distal end of the dip pipe 306 and the flow guide 312, the liquid fractions and entrained solids continue to flow in a helical path, as indicated by the arrows 400. The liquid flows in a helical path past the end cap 322 on the stand pipe 320 and over the surface of the flow guide 326 on the distal end of the stand pipe 320. Oil, being the lightest liquid phase, collects in the radially innermost region of the vessel and flows into the stand pipe 320 through the opening 324. The curved surface of the flow guide 326 induces a spiral coanda effect in the liquid flowing thereover, further enhancing the separation of the oil and water phases and entrained solids. In particular, the spiral coanda effect forms a rotational layer of the lighter liquid around the flow guide 326 with a flow in the upstream direction, causing the oil to flow upstream over the flow guide 326 and the stand pipe 320 into the opening 324, as indicted by the arrows 416 in FIG. 4. Heavier liquid phases and entrained solids move outwards towards the wall of the vessel and flow in a downstream direction.

As shown in FIG. 4, two distinct fluid streams are formed in the region of the flow guide 326 around the stand pipe. The first fluid stream is the flow of fluid over the surface of the flow guide in the upstream direction, induced by the spiral coanda effect. The second stream is the bulk fluid stream rotating within the vessel, with the heavier fluid components collecting in the radially outer regions of the vessel. The first and second fluid streams are separated by a boundary 420.

Downstream of the flow guide, medium to fine solid particles entrained in heavier fluid are withdrawn from the central region of the vessel through the opening 344 in the outer pipe 340 around the stand pipe 320, enter the annular conduit 342 and leave the vessel through the outlet 346. Heavier liquid, in particular water and larger particles of entrained solids settle in the downstream end portion of the vessel and are removed from the vessel through the outlet 348.

1. An apparatus for controlling the flow of a first fluid stream within a bulk rotating fluid stream, the apparatus comprising:
a fluid flow region having a longitudinal axis, within which a rotating flow of fluid may be established;
a flow guide having a convex outer surface disposed centrally within the fluid flow region, the convex outer surface of the flow guide extending parallel to the longitudinal axis of the fluid flow region, the convex surface being shaped to induce a spiral coanda effect in the flow of the first fluid stream over the flow guide.

2. The apparatus according to claim 1, the apparatus comprising:
a vessel comprising a separation region;
an inlet for the multiphase fluid stream;
means for imparting a rotational flow to the fluid stream such that the fluid stream flows in a downstream helical path within the vessel;
a conduit extending within the vessel having an opening in the end portion thereof to provide an outlet for a fluid fraction from the separation region of the vessel;
a flow guide on the distal end of the conduit, the flow guide having a lateral dimension greater than that of the conduit and a convex outer surface to induce a spiral coanda effect in a flow of fluid over the flow guide, thereby directing the fluid into the opening in the conduit.

3. The apparatus according to either of claim 1 or 2, wherein the flow guide has a breakaway point adjacent or close to a fluid outlet.

4. The apparatus according to claim 2, wherein the separation region of the vessel is cylindrical.

5. The apparatus according to claim 2, comprising a plurality of fluid inlets.

6. The apparatus according to claim 2, wherein the or each fluid inlet is rectangular in cross-section.

7. The apparatus according to claim 2, wherein the or each fluid inlet is oriented at an angle to the radial axis of the vessel.

8. The apparatus according to claim 7, wherein the or each fluid inlet is tangential to the radial axis of the vessel.

9. The apparatus according to claim 2, wherein the or each fluid inlet is oriented at an angle to the longitudinal axis of the vessel, such that fluid entering the vessel is directed downstream of the fluid inlet.

10. The apparatus according to claim 9, wherein the or each fluid inlet is oriented such that fluid entering the vessel is prevented from colliding with fluid present and rotating in the vessel.

11. The apparatus according to claim 2, further comprising one or more guides or guides surfaces to induce a rotational flow pattern in the fluid in the vessel.

12. The apparatus according to claim 2, wherein the conduit extends axially within the vessel.

13. The apparatus according to claim 2, wherein the conduit is disposed to remove a relatively lower density fluid from the separation region.

14. The apparatus according to claim 13, wherein the lighter fluid is caused to flow over the surface of the flow guide in an upstream direction towards the opening.

15. The apparatus according to claim 14, apparatus comprising:
the conduit extending within the vessel and having an opening in the end portion thereof to provide an outlet for a lighter fluid fraction from a central region of the separation region of the vessel; and
a flow guide on the distal end of the conduit and disposed downstream of the opening in the end portion of the conduit, the flow guide having a convex surface and a lateral dimension greater than that of the conduit and an outer surface to induce a spiral coanda effect in a flow of lighter fluid over the flow guide, thereby directing the lighter fluid into the opening in the conduit.

16. The apparatus according to claim 13, wherein the conduit extends into the separation region from the upstream end of the vessel.

17. The apparatus according to claim 2, wherein the conduit is disposed to remove a relatively higher density fluid from the separation region.

18. The apparatus according to claim 17, wherein the heavier fluid is caused to flow over the surface of the flow guide in a downstream direction towards the opening.

19. The apparatus according to claim 18, apparatus comprising:
the conduit extending within the vessel and having an opening in the end portion thereof to provide an outlet for a heavier fluid fraction from a central region of the separation region of the vessel; and
a flow guide on the distal end of the conduit and disposed upstream of the opening in the end portion of the conduit, the flow guide having a convex surface and a lateral dimension greater than that of the conduit and an outer surface to induce a spiral coanda effect in a flow of heavier fluid over the flow guide, thereby directing the heavier fluid into the opening in the conduit.

20. The apparatus according to claim 17, wherein the conduit extends into the separation region from the downstream end of the vessel.

21. The apparatus according to claim 2, wherein the opening in the conduit faces radially outwards.

22. The apparatus according to claim 21, wherein the opening in the conduit is arranged to extend tangentially to the direction of rotation of the flow of fluid within the vessel.

23. The apparatus according to claim 21, wherein the opening is provided in a portion of the wall of the conduit extending parallel to the longitudinal axis of the vessel.

24. The apparatus according to claim 2,
wherein the opening in the conduit comprises a plurality of apertures.

25. The apparatus according to claim 2, wherein the opening is disposed at a position displaced from the distal end of the conduit.

26. The apparatus according to claim 2, wherein the flow guide has a continuous curved surface that is presented to the flow of fluid passing thereover.

27. The apparatus according to claim 26, wherein the flow guide is bulb-shaped or dome-shaped.

28. The apparatus according to claim 2, the apparatus comprising:
a first conduit extending in downstream direction within the separation region in the vessel and provided with and opening and a flow guide at its distal end, for the removal of a lighter fluid fraction; and
a second conduit extending within separation region in the vessel in an upstream direction, the second conduit being provided with an opening through which a heavier fluid fraction is removed from the separation region and a flow guide at its distal end.

29. The apparatus according to claim 2, wherein the conduit is for removing a heavier fluid fraction in a downstream direction, the flow guide comprising one or more ports or channels therethrough for the passage of lighter fluid from the region downstream of the flow guide to the region upstream of the flow guide.

30. A method for controlling the flow of a first fluid stream within a bulk rotating fluid stream, the method comprising:
providing a bulk fluid stream and imparting a rotational flow pattern to the bulk fluid to induce a first fluid fraction to form in the innermost region of the flow pattern;
causing the first fluid fraction to flow as the first fluid stream over the convex surface of a flow guide to induce a spiral coanda effect, thereby allowing the direction and orientation of the flow of the first fluid stream to be controlled.

31. The method of claim 30, for separating a multiphase fluid stream, the fluid stream comprising a relatively high density component and a relatively low density component, the method comprising:
introducing the multiphase fluid into a separation zone;
imparting a rotational movement into the fluid, whereby a lighter fluid fraction is caused to collect in the radially central region of the separation zone and a heavier fluid faction is caused to collect in the radially outer region of the separation zone;
inducing a spiral coanda flow in a fluid fraction to direct the fluid fraction towards a fluid outlet disposed and thereby removing the fluid fraction from the separation zone.

32. The method according to claim 30, wherein the fluid stream comprises one or more liquid phases, a liquid and a gas phase, or a combination thereof.

33. The method according to claim 30, wherein the fluid stream is produced from a subterranean oil or gas well.

34. The method according to claim 31, the method comprising:
providing an outlet for low density fluid in a central region of the separation zone;
providing a flow guide downstream of the outlet, the flow guide inducing a spiral coanda flow of low density fluid in the upstream direction and directing the low density fluid inwards towards the outlet.

35. The method according to claim 31, the method comprising:
providing an outlet for high density fluid in the separation zone;
providing a flow guide upstream of the outlet, the flow guide inducing a spiral coanda flow of high density fluid in the downstream direction and directing the high density fluid towards the outlet.

36. A wellhead installation comprising an apparatus, wherein the apparatus further comprises:
a fluid flow region having a longitudinal axis, within which a rotating flow of fluid may be established:
flow guide having a convex outer surface disposed centrally within the fluid flow region, the convex outer surface of the flow guide extending parallel to the longitudinal axis of the fluid flow region, the convex surface being shaped to induce a spiral coanda effect in the flow of the first fluid stream over the flow guide.

37. The wellhead installation according to claim 36, wherein the apparatus is located subsea.

38. A method of producing a fluid stream from a subterranean oil or gas well, comprising providing a bulk fluid stream and imparting a rotational flow pattern to the bulk fluid to induce a first fluid fraction to form in the innermost region of the flow pattern; causing the first fluid fraction to flow as the first fluid stream over the convex surface of a flow guide to induce a spiral coanda effect, thereby allowing the direction and orientation of the flow of the first fluid stream to be controlled.

39. (canceled)

40. (canceled)
